(19) United States
(12) Patent Application Publication
(10) Pub. No.: US 2026/0266736 A1
(43) Pub. Date: Sep. 10, 2026

(54) APPEARANCE INSPECTION DEVICE

(71) Applicant: MITSUBISHI HEAVY INDUSTRIES, LTD., Tokyo (JP)

(72) Inventors: Takahito SHIMOMUKAI, Tokyo (JP); Shota KURODA, Tokyo (JP); Koji KOBAYASHI, Tokyo (JP); Takeshi HAGINO, Namerikawa City (JP); Yohei SAKAI, Namerikawa City (JP); Shinichi TAKEYAMA, Namerikawa City (JP); Soushi YAMAMOTO, Namerikawa City (JP)

(21) Appl. No.: 19/545,020

(22) Filed: Feb. 20, 2026

(30) Foreign Application Priority Data
Mar. 7, 2025 (JP) 2025-036549

(51) Int. Cl. G01N 21/88; G03B 17/56

(52) U.S. Cl. CPC G01N 21/8806; G03B 17/561; G01N 2021/8835; G01N 2021/8841

(57) ABSTRACT

An appearance inspection device includes: a movable frame including a guide rail extending in a scanning direction; a first traveling unit and a second traveling unit that are capable of traveling on an object placement surface in a travel direction perpendicular to the scanning direction; a scanning-direction movable unit attached to the guide rail and movable in the scanning direction; a camera unit attached to the scanning-direction movable unit and including a camera capable of imaging an object placed on the object placement surface; and a controller. The controller operates the scanning-direction movable unit and causes the camera to image the object while the camera unit is moving in the scanning direction.

### CROSS-REFERENCE TO RELATED APPLICATIONS

This application claims the benefit of priority to Japanese Patent Application Number 2025-036549 filed on Mar. 7, 2025. The entire contents of the above-identified application are hereby incorporated by reference.

### TECHNICAL FIELD

The disclosure relates to an appearance inspection device that inspects an appearance of an object.

### RELATED ART

JP 2017-161354 A discloses an inspection device that inspects the appearance of an object. This inspection device includes a movable frame placed on an object placement surface, a plurality of rollers attached to this movable frame, and an imaging device (camera) attached to this movable frame. The movable frame includes a beam extending in a horizontal Y direction, a first leg extending downward from an end on one side in the horizontal Y direction of this beam, and a second leg extending downward from an end on the other side in the horizontal Y direction of this beam. A roller capable of rolling in a horizontal X direction is provided under the first leg. A roller capable of rolling in the horizontal X direction is provided under the second leg. The imaging device (camera) is provided on the beam of the movable frame.

### SUMMARY

In the technique described in JP 2017-161354 A, the movement direction of the imaging device (camera) is limited to the X direction, and in a case where an object spreads greatly in the horizontal Y direction perpendicular to the horizontal X direction, the entire appearance of the object cannot be imaged. That is, the technique described in JP 2017-161354 A is unsuitable in a case where the size of the object is large with respect to the coverage area of the imaging device (camera). In this manner, in a case where the size of the object is large with respect to the coverage area of the imaging device (camera), the camera vibrates with the movement of the camera in the horizontal direction, the focus of the camera is blurred, and accuracy of appearance inspection of the object may be deteriorated.

Therefore, an object of the disclosure is to provide an appearance inspection device capable of suppressing the vibration of a camera during imaging of an object by the camera and improving the accuracy of the appearance inspection of the object.

An appearance inspection device as one aspect for achieving the object includes: a movable frame including a guide rail extending in a scanning direction; a first traveling unit and a second traveling unit that are capable of traveling on an object placement surface in a travel direction perpendicular to the scanning direction; a scanning-direction movable unit attached to the guide rail and movable in the scanning direction along the guide rail; a camera unit attached to the scanning-direction movable unit and including a camera capable of imaging an object placed on the object placement surface and an illuminator capable of illuminating an imaging region of the camera; and a controller capable of controlling respective operations of the first traveling unit, the second traveling unit, the scanning-direction movable unit, and the camera. The movable frame includes a first leg configured to support an end of the guide rail on a first scanning side, which is one side in the scanning direction, and extending in a direction having a component in a vertical direction Dv and a second leg configured to support an end of the guide rail on a second scanning side opposite to the first scanning side in the scanning direction and extending in a direction having the component in the vertical direction Dv. The first traveling unit is attached to a lower end of the first leg. The second traveling unit is attached to a lower end of the second leg. The controller operates the scanning-direction movable unit and causes the camera to image the object while the camera unit is moving in the scanning direction.

In the present aspect, since the movement of the movable frame and the camera unit in the travel direction by the operation of the first traveling unit and the second traveling unit and the movement of the camera unit in the scanning direction perpendicular to the travel direction by the operation of the scanning-direction movable unit are possible, the appearance inspection of an object is possible even in a case where the size of this object is large with respect to the imaging region of the camera.

The object placement surface may have distortion or fine unevenness. Therefore, during the movement of the movable frame and the camera unit in the travel direction by the operation of the first traveling unit and the second traveling unit, the camera unit vibrates due to distortion and fine unevenness of the object placement surface. In the present aspect, the camera is caused to image the object while the camera unit is moving in the scanning direction along the guide rail. Therefore, in the present aspect, it is possible to suppress the vibration of a camera during imaging of an object by the camera and improve the accuracy of the appearance inspection of the object.

One aspect of the disclosure can suppress the vibration of a camera during imaging of an object by the camera and improve the accuracy of the appearance inspection of the object.

### BRIEF DESCRIPTION OF DRAWINGS

The disclosure will be described with reference to the accompanying drawings, wherein like numbers reference like elements.

FIG. 1 is a perspective view of an appearance inspection device in one embodiment according to the disclosure.

FIG. 2 is a plan view of the appearance inspection device in one embodiment according to the disclosure.

FIG. 3 is a front view of the appearance inspection device in one embodiment according to the disclosure.

FIG. 4 is a side view of the appearance inspection device in one embodiment according to the disclosure.

FIG. 5 is a front view of a camera unit in one embodiment according to the disclosure.

FIG. 6 is an explanatory diagram illustrating a relative positional relationship among each camera, an imaging region thereof, and an illumination region of each illuminator in one embodiment according to the disclosure.

FIG. 7 is an explanatory diagram illustrating an operation of a marker in one embodiment according to the disclosure.

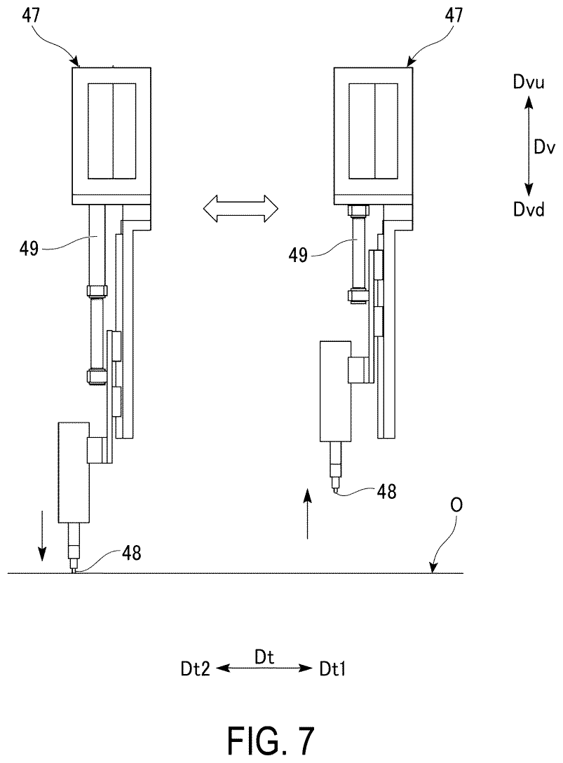

FIG. 8 is a functional block diagram of a controller in one embodiment according to the disclosure.

FIG. 9 is an explanatory diagram illustrating an operation of a lifting unit during movement of the camera unit in one embodiment according to the disclosure in a travel direction to a first scanning side.

FIG. 10 is a plan view of the appearance inspection device illustrating a movement stage of the camera unit in one embodiment according to the disclosure to the first scanning side.

FIG. 11 is a plan view of the appearance inspection device illustrating a movement stage of the camera unit in one embodiment according to the disclosure to a second scanning side.

FIG. 12 is a plan view of the appearance inspection device illustrating a movement stage of the camera unit in one embodiment according to the disclosure to a first travel side.

### DESCRIPTION OF EMBODIMENTS

Hereinafter, one embodiment of an appearance inspection device according to the disclosure will be described with reference to the drawings.

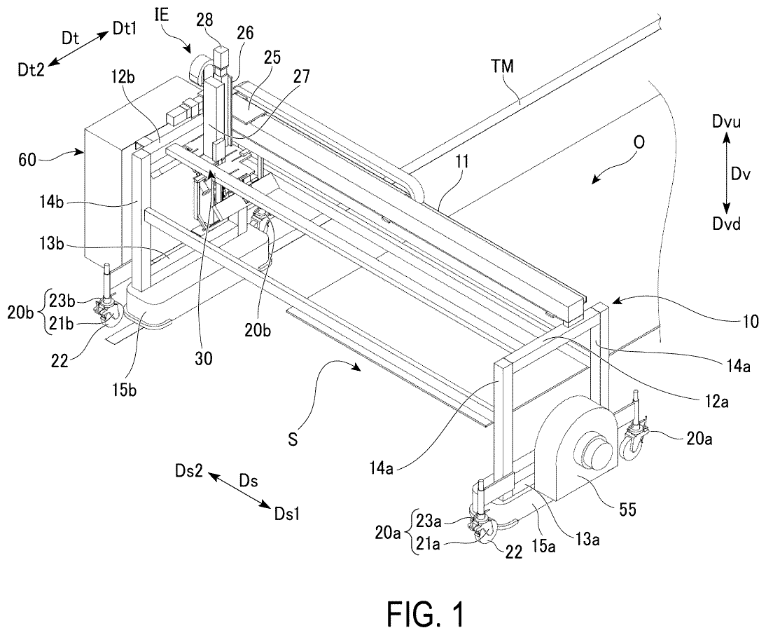

As illustrated in FIG. 1, an appearance inspection device IE in the present embodiment is a device that inspects a surface of an object O having a rectangular plate-like shape placed on an object placement surface S.

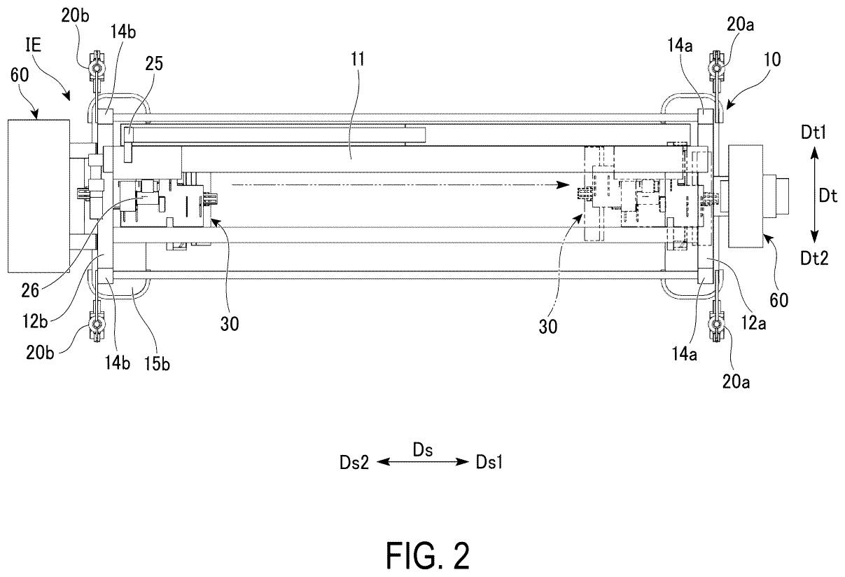

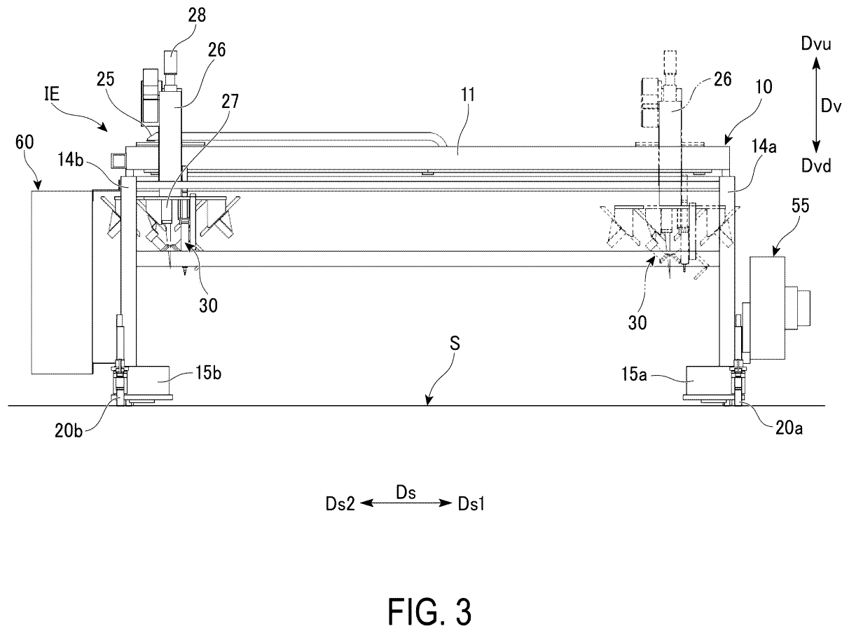

As illustrated in FIGS. 1 to 4, the appearance inspection device IE includes a movable frame 10, a first traveling unit 15a, a second traveling unit 15b, a pair of first jack casters 20a, a pair of second jack casters 20b, a scanning-direction movable unit 25, a lifting unit 26, a camera unit 30, a cable reel 55, and a controller 60.

The movable frame 10 includes a guide rail 11 extending in a scanning direction Ds, a first upper beam 12a extending in a travel direction Dt perpendicular to the scanning direction Ds, a first lower beam 13a extending in the travel direction Dt, a second upper beam 12b extending in the travel direction Dt, a second lower beam 13b extending in the travel direction Dt, a pair of first legs 14a extending in the vertical direction Dv, and a pair of second legs 14b extending in the vertical direction Dv.

Here, one side in the scanning direction Ds is defined as a first scanning side Ds1, and a side opposite to the first scanning side Ds1 in the travel direction Dt is defined as a second scanning side Ds2. One side in the travel direction Dt is defined as a first travel side Dt1, and a side opposite to the first travel side Dt1 in the travel direction Dt is defined as a second travel side Dt2.

The first upper beam 12a is fixed to an end on the first scanning side Ds1 of the guide rail 11. One first leg 14a of the pair of first legs 14a extends vertically downward Dvd from an end on the first travel side Dt1 of the first upper beam 12a. The other first leg 14a of the pair of first legs 14a extends vertically downward Dvd from an end on the second travel side Dt2 of the first upper beam 12a. Therefore, the pair of first legs 14a supports the end of on the first scanning side Ds1 the guide rail 11. The first lower beam 13a couples lower portions of the pair of first legs 14a to each other.

The second upper beam 12b is fixed to an end on the second scanning side Ds2 of the guide rail 11. One second leg 14b of the pair of second legs 14b extends vertically downward Dvd from an end on the first travel side Dt1 of the second upper beam 12b. The other second leg 14b of the pair of second legs 14b extends vertically downward Dvd from an end on the second travel side Dt2 of the second upper beam 12b. Therefore, the pair of second legs 14b supports the end on the second scanning side Ds2 of the guide rail 11. The second lower beam 13b couples lower portions of the pair of second legs 14b to each other.

Both the first traveling unit 15a and the second traveling unit 15b can travel in the travel direction Dt. The first traveling unit 15a is attached to lower ends of the pair of first legs 14a. The second traveling unit 15b is attached to lower ends of the pair of second legs 14b.

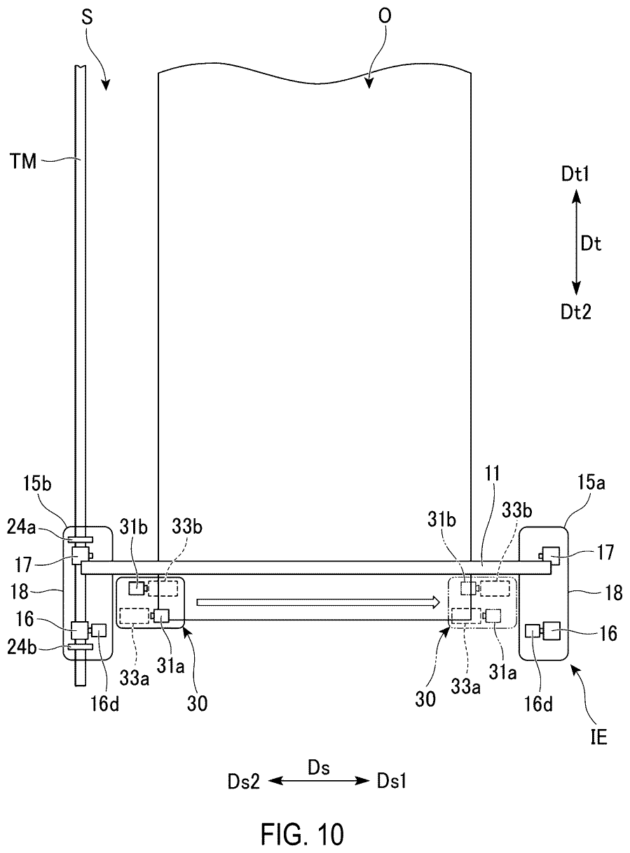

As illustrated in FIG. 10, both the first traveling unit 15a and the second traveling unit 15b include a driving wheel 16, a driven wheel 17, a driving unit 16d configured to rotate the driving wheel 16, and a traveling-unit cover 18 that covers the driving wheel 16, the driven wheel 17, and the driving unit 16d. The driven wheel 17 is arranged on the first travel side Dt1 of the driving wheel 16. The driving wheel 16, the driven wheel 17, and the driving unit 16d are all attached to the traveling-unit cover 18. A first mark sensor 24a and a second mark sensor 24b are arranged in the traveling-unit cover 18 of one of the first traveling unit 15a and the second traveling unit 15b. Both the first mark sensor 24a and the second mark sensor 24b are sensors provided on the object placement surface S and capable of detecting the position in the scanning direction Ds of a travel direction mark TM extending in the travel direction Dt. Specifically, the travel direction mark TM is a magnetic tape. Both the first mark sensor 24a and the second mark sensor 24b are magnetic sensors. The first mark sensor 24a is arranged on the first travel side Dt1 of the driven wheel 17. The second mark sensor 24b is arranged on the second travel side Dt2 of the driving wheel 16.

As illustrated in FIGS. 1 to 4, the pair of first jack casters 20a includes a pair of first casters 21a each having a wheel 22 capable of rolling on the object placement surface S, and a pair of first jacks 23a. One first caster 21a of the pair of first casters 21a is arranged on the first travel side Dt1 of the first traveling unit 15a, and the other first caster 21a is arranged on the second travel side Dt2 of the first traveling unit 15a. One first jack 23a of the pair of first jacks 23a can lift the first leg 14a on the first travel side Dt1 with respect to the first caster 21a on the first travel side Dt1. The other first jack 23a can lift the first leg 14a on the second travel side Dt2 with respect to the first caster 21a on the second travel side Dt2.

The pair of second jack casters 20b includes a pair of second casters 21b each having the wheel 22 capable of rolling on the object placement surface S, and a pair of second jacks 23b. One second caster 21b of the pair of second casters 21b is arranged on the first travel side Dt1 of the second traveling unit 15b, and the other second caster 21b is arranged on the second travel side Dt2 of the second traveling unit 15b. One second jack 23b of the pair of second jacks 23b can lift the second leg 14b on the first travel side Dt1 with respect to the second caster 21b on the first travel side Dt1. The other second jack 23b can lift the second leg 14b on the second travel side Dt2 with respect to the second caster 21b on the second travel side Dt2.

The scanning-direction movable unit 25 is attached to the guide rail 11 and is movable in the scanning direction Ds along this guide rail 11. The lifting unit 26 includes a vertical operation portion 27 movable in the vertical direction Dv and a lifting actuator 28 configured to move this vertical operation portion 27 in the vertical direction Dv. The lifting actuator 28 is attached to the scanning-direction movable unit 25. The camera unit 30 is attached to the vertical operation portion 27. Therefore, this lifting unit 26 can relatively move the camera unit 30 in the vertical direction Dv with respect to the scanning-direction movable unit 25.

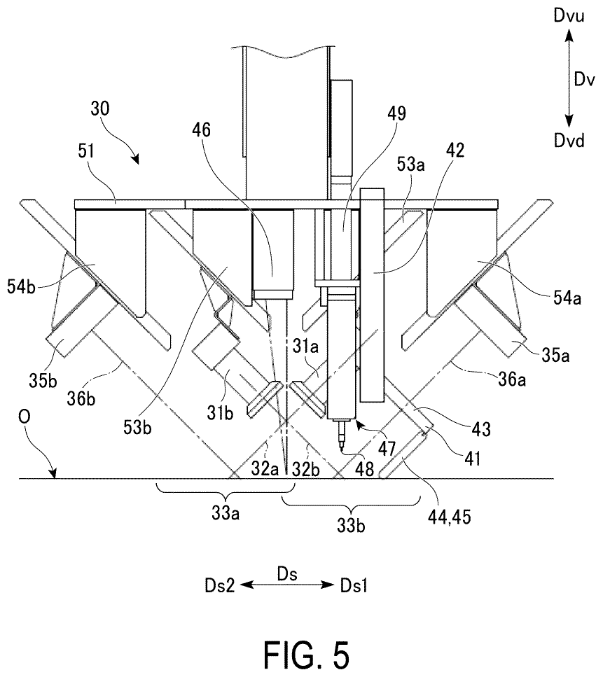

As illustrated in FIG. 5, the camera unit 30 includes a first camera 31a, a second camera 31b, a first illuminator 35a, a second illuminator 35b, a wiper 41, a distance meter 46, a marker 47, a unit base 51, a first camera mount 53a, a second camera mount 53b, a first illuminator mount 54a, and a second illuminator mount 54b.

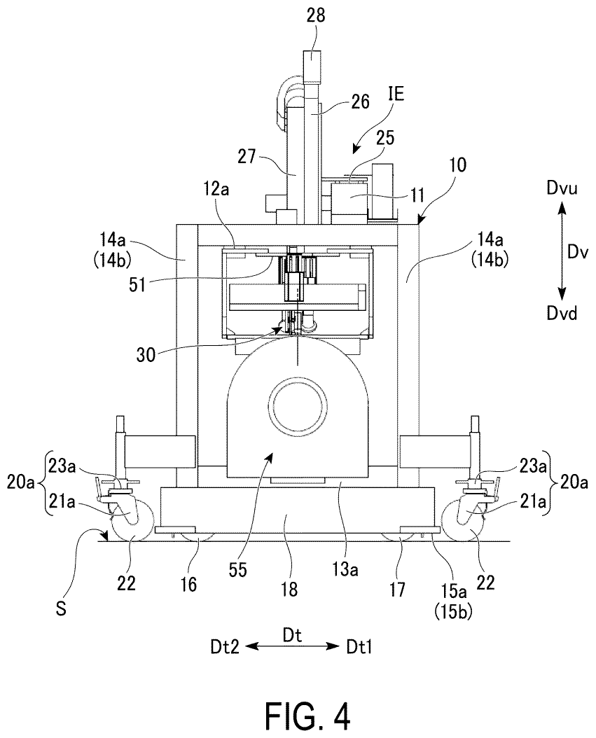

The unit base 51 is fixed to the vertical operation portion 27 of the lifting unit 26 (see FIG. 4). The first camera mount 53a, the first illuminator mount 54a, the second camera mount 53b, and the second illuminator mount 54b are all attached to this unit base 51 relatively movably in the travel direction Dt with respect to the unit base 51.

The first camera 31a is attached to the first camera mount 53a movably in a direction in which an optical axis 32a of this first camera 31a gradually moves to the second scanning side Ds2 as it moves vertically downward Dvd in a virtual plane spreading in the scanning direction Ds and the vertical direction Dv, and this optical axis 32a extends. The first illuminator 35a can illuminate an imaging region 33a of the first camera 31a. This first illuminator 35a is attached to the first illuminator mount 54a movably in a direction in which an optical axis 36a of the first illuminator 35a gradually moves to the second scanning side Ds2 as it moves vertically downward Dvd, and this optical axis 36a extends. The optical axis 32a of the first camera 31a and the optical axis 36a of the first illuminator 35a are substantially parallel to each other.

The second camera 31b is attached to the second camera mount 53b movably in a direction in which an optical axis 32b of this second camera 31b gradually moves to the first scanning side Ds1 as it moves vertically downward Dvd in a virtual plane spreading in the scanning direction Ds and the vertical direction Dv, and this optical axis 32b extends. The second camera 31b is arranged on the second scanning side Ds2 and on the first travel side Dt1 with respect to the first camera 31a. The second illuminator 35b can illuminate an imaging region 33b of the second camera 31b. The second illuminator 35b is attached to the second illuminator mount 54b movably in a direction in which an optical axis 36b of the second illuminator 35b gradually move to the first scanning side Ds1 as it moves vertically downward Dvd, and this optical axis 36b extends. As described above, this second illuminator mount 54b is arranged on the second scanning side Ds2 relative to the first illuminator mount 54a. As described above, since the second illuminator mount 54b is attached to the second base 52b, the second illuminator 35b is arranged on the second scanning side Ds2 with respect to the first illuminator 35a. The optical axis 32b of the second camera 31b and the optical axis 36b of the second illuminator 35b are substantially parallel to each other.

In the present embodiment, two regions different from each other in the travel direction Dt can be imaged by the two cameras 31a and 31b by one movement of the camera unit 30 in the scanning direction Ds. Therefore, in the present embodiment, it is possible to efficiently inspect the surface of the object O.

Movement adjustment of the first camera mount 53a, the first illuminator mount 54a, the second camera mount 53b, and the second illuminator mount 54b with respect to the unit base 51 in the travel direction Dt is performed before a worker inspects the object O with this appearance inspection device IE. Movement adjustment of the first camera 31a with respect to the first camera mount 53a, movement adjustment of the second camera 31b with respect to the second camera mount 53b, movement adjustment of the first illuminator 35a with respect to the first illuminator mount 54a, and movement adjustment of the second illuminator 35b with respect to the second illuminator mount 54b are also performed before the worker inspects the object O with this appearance inspection device IE.

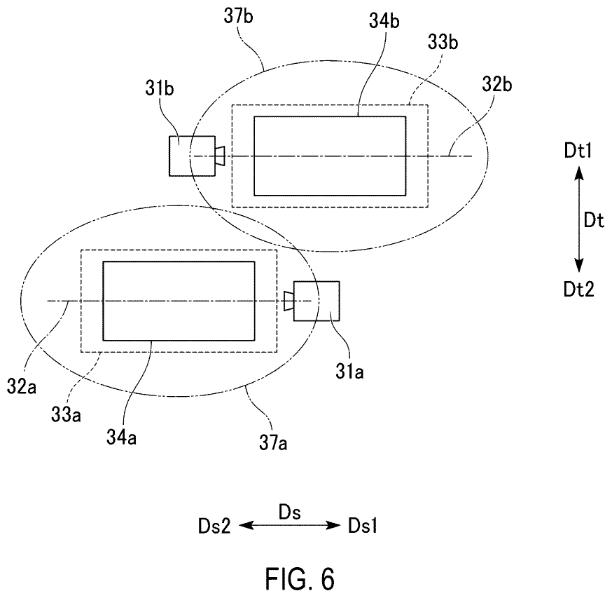

As described above, since the first camera 31a, the second camera 31b, the first illuminator 35a, and the second illuminator 35b are arranged, as illustrated in FIG. 6, the imaging region 33b of the second camera 31b is located on the first scanning side Ds1 and on the first travel side Dt1 relative to the imaging region 33a of the first camera 31a. An illumination region 37b of the second illuminator 35b capable of illuminating the imaging region 33b of the second camera 31b is on the first scanning side Ds1 and on the first travel side Dt1 with respect to an illumination region 37a of the first illuminator 35a capable of illuminating the imaging region 33a of the first camera 31a.

As illustrated in FIG. 5, the wiper 41 is arranged on the first scanning side Ds1 relative to the first camera 31a and the second camera 31b. When the camera unit 30 is moving to the first scanning side Ds1, this wiper 41 contacts the surface of the object O and capable of removing foreign matter on this surface. The wiper 41 includes a wiper base 42, a wiper arm 43, a sheet attachment rubber plate 44, and a wiping sheet 45. The wiper base 42 is fixed to the unit base 51 so as to be positioned on the first scanning side Ds1 relative to the first camera 31a. The wiper arm 43 is fixed to this wiper base 42. The sheet attachment rubber plate 44 is attached to the wiper arm 43 such that the direction in which this sheet attachment rubber plate 44 spreads gradually spreads to the second scanning side Ds2 as it moves vertically downward Dvd. The wiping sheet 45 is attached to this sheet attachment rubber plate 44 so as to cover this sheet attachment rubber plate 44.

The distance meter 46 can measure the distance to the surface of the object O on the object placement surface S. This distance meter 46 is, for example, a laser distance sensor. This distance meter 46 is fixed to the unit base 51. This distance meter 46 is arranged between the first camera 31a and the second camera 31b in the travel direction Dt and between the first camera 31a and the second camera 31b in the scanning direction Ds.

The marker 47 includes a marking pen 48 capable of marking a defect-suspected mark on the surface of the object, and a pen-lifting actuator 49 capable of moving the marking pen 48 in the vertical direction Dv. The marking material of the marking pen 48 is formed of a material that can remove the defect-suspected mark marked on the object O without using a solvent and does not damage the object O. Therefore, in the present embodiment, the worker can easily remove the defect-suspected mark on the surface of the object O without damaging the object O. The pen-lifting actuator 49 is attached to the unit base 51.

The cable reel 55 includes a power supply cable electrically connectable to a power supply outlet in an inspection chamber having the object placement surface S. As illustrated in FIG. 1, this cable reel 55 is attached to one leg of the first leg 14a and the second leg 14b.

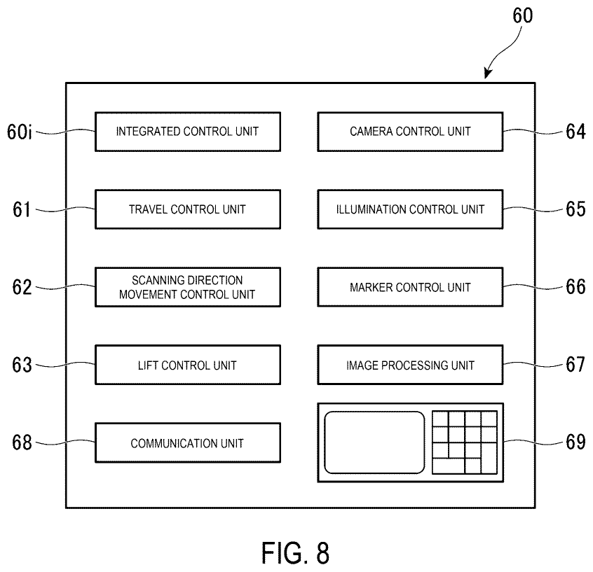

As illustrated in FIG. 1, the controller 60 is attached to the other leg of the first leg 14a and the second leg 14b. As illustrated in FIG. 8, this controller 60 includes a travel control unit 61, a scanning direction movement control unit 62, a lift control unit 63, a camera control unit 64, an illumination control unit 65, a marker control unit 66, an image processing unit 67, a communication unit 68, an input/output unit 69, and an integrated control unit 60i. The travel control unit 61 controls the operation of the first traveling unit 15a and the second traveling unit 15b. The scanning direction movement control unit 62 controls the operation of the scanning-direction movable unit 25. The lift control unit 63 controls the operation of the lifting unit 26. The camera control unit 64 controls the imaging operation and the like of the first camera 31a and the second camera 31b. The illumination control unit 65 controls the illumination operation of the first illuminator 35a and the second illuminator 35b. The marker control unit 66 controls the operation of the pen-lifting actuator 49. The image processing unit 67 identifies a defect-suspected portion on the surface of the object O based on the imaging data obtained by the first camera 31a and the second camera 31b. The communication unit 68 outputs, to the outside, the imaging data obtained by the first camera 31a and the second camera 31b and the defect-suspected portion identified by the image processing unit 67. The input/output unit 69 includes a display and an input key. The integrated control unit 60i integrally manages the above-described control units and the like to control the operation of the above-described control units and the like.

Next, the handling of the appearance inspection device IE described above and the operation of this appearance inspection device IE will be described.

As illustrated in FIG. 10, first, the worker places the object O on the object placement surface S. At this time, the object O is arranged such that the object O is aligned along the travel direction mark TM provided on the object placement surface S, and the longitudinal direction of the object O having a rectangular plate-like shape is the direction in which the travel direction mark TM extends.

Next, the worker operates the first jack 23a to jack up the first leg 14a with this first jack 23a, and operates the second jack 23b to jack up the second leg 14b with this second jack 23b. As a result, the driving wheel 16 and the driven wheel 17 of the first traveling unit 15a and the driving wheel 16 and the driven wheel 17 of the second traveling unit 15b are separated upward from the object placement surface S. Then, the worker pushes the appearance inspection device IE to move the appearance inspection device IE to a target position on the object placement surface S. At this time, the wheel 22 of the first caster 21a and the wheel 22 of the second caster 21b roll on the object placement surface S. Here, the target position is a position where the first camera 31a and the second camera 31b are capable of imaging the end portion of the object O in the longitudinal direction, and the first mark sensor 24a and the second mark sensor 24b are positioned on the travel direction mark TM. Next, the worker operates the first jack 23a to jack down the first leg 14a with this first jack 23a, and operates the second jack 23b to jack down the second leg 14b with this second jack 23b. As a result, the driving wheel 16 and the driven wheel 17 of the first traveling unit 15a, and further, the driving wheel 16 and the driven wheel 17 of the second traveling unit 15b come into contact with the object placement surface S. In this state, the travel direction Dt of the appearance inspection device IE coincides with the longitudinal direction of the object O having a rectangular plate-like shape, and the scanning direction Ds of the appearance inspection device IE coincides with the transverse direction of the object O having a rectangular plate-like shape.

In the present embodiment, since the appearance inspection device IE includes the first jack caster 20a and the second jack caster 20b, the appearance inspection device IE can be easily moved to a target position on the object placement surface S.

This completes the inspection preparation.

When the inspection preparation is completed, the worker operates the input/output unit 69 of the controller 60 to cause the appearance inspection device IE to start the appearance inspection of the object O.

The illumination control unit 65 of the controller 60 causes the first illuminator 35a and the second illuminator 35b to illuminate. The camera control unit 64 of the controller 60 causes the first camera 31a and the second camera 31b to image. Furthermore, the scanning direction movement control unit 62 operates the scanning-direction movable unit 25 and moves the camera unit 30 from the second scanning side Ds2 to the first scanning side Ds1.

As described above, the wiper 41 is arranged on the first scanning side Ds1 relative to the first camera 31a and the second camera 31b. Therefore, with the movement of the camera unit 30 to the first scanning side Ds1, the imaging regions 33a and 33b of the cameras 31a and 31b are cleaned by the wiper 41 on the surface of the object O. Therefore, in the present embodiment, it is possible to reduce erroneous detection of a defect-suspected portion due to foreign matter when detecting the defect-suspected portion of the object O based on the image data obtained by the first camera 31a and the second camera 31b.

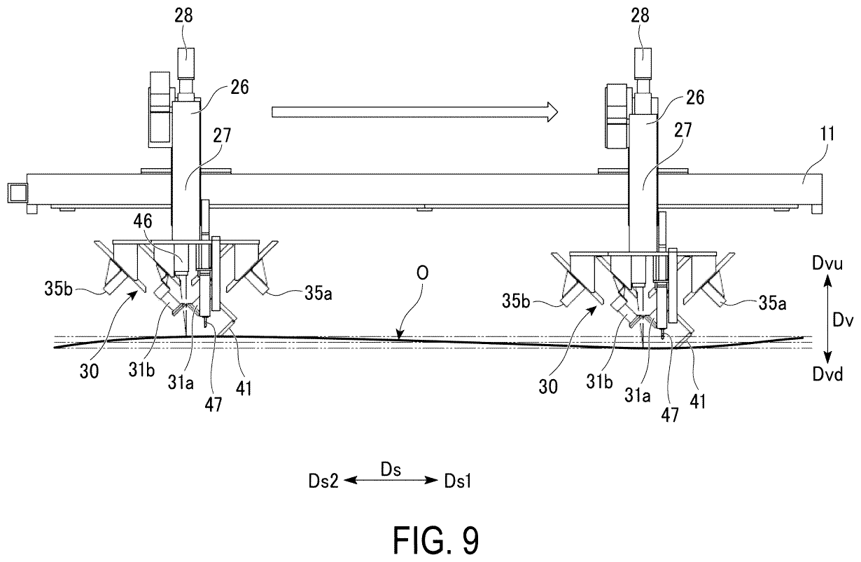

In the movement stage of the camera unit 30 to the first scanning side Ds1, the distance meter 46 detects the distance to the surface of the object O. This detection result is sent to the lift control unit 63 of the controller 60. Based on the distance detected by the distance meter 46, the lift control unit 63 controls the lifting unit 26 so that the distance from each of the cameras 31a and 31b to a portion to be imaged by the cameras 31a and 31b on the surface of the object O becomes a predetermined distance. Therefore, as illustrated in FIG. 9, even if the surface of the object O is displaced in the vertical direction Dv according to the position in the scanning direction Ds, the cameras 31a and 31b are focused on the surface of the object O, and the illumination intensity in the illumination regions 37a and 37b (see FIG. 6) on the surface of the object O becomes constant. Furthermore, the contact pressure between the wiper 41 and the surface of the object O also becomes constant.

The image processing unit 67 of the controller 60 sequentially analyzes the image data obtained by the first camera 31a and the second camera 31b during the above scanning. At this time, as illustrated in FIG. 6, the image processing unit 67 identifies the defect-suspected portion on the surface of the object O based on the imaging data of an effective imaging region 34a in which the illumination intensity by the first illuminator 35a is equal to or more than a predetermined illumination intensity in the imaging region 33a of the first camera 31a. Furthermore, the image processing unit 67 identifies the defect-suspected portion on the surface of the object O based on the imaging data of an effective imaging region 34b in which the illumination intensity by the second illuminator 35b is equal to or more than the predetermined illumination intensity in the imaging region 33b of the second camera 31b. Therefore, in the present embodiment, it is possible to reduce erroneous detection of the defect-suspected portion.

The effective imaging regions 34a and 34b in the present embodiment are 50% to 70% of the imaging regions 33a and 33b of the cameras 31a and 31b. The illumination intensities of the first illuminator 35a and the second illuminator 35b are adjustable by scanning of the input/output unit 69 of the controller 60. However, in a case where each of the first illuminator 35a and the second illuminator 35b is provided with an adjustment knob of the illumination intensity, the illumination intensities of the first illuminator 35a and the second illuminator 35b may be adjusted by operating this adjustment knob.

The image processing unit 67 has a threshold value for each of a plurality of defect types. The image processing unit 67 extracts feature data for each of the defect types from the imaging data, and determines that this feature data is data having a high possibility of a defect in a case where this feature data exceeds a threshold value. The position where the feature data is obtained is defined as a defect-suspected portion.

When the camera unit 30 reaches the limit position on the first scanning side Ds1 in the guide rail 11, the illumination control unit 65 causes the first illuminator 35a and the second illuminator 35b to stop the illumination operation, and the camera control unit 64 causes the first camera 31a and the second camera 31b to stop the imaging operation. Furthermore, the scanning direction movement control unit 62 operates the scanning-direction movable unit 25 and moves the camera unit 30 from the first scanning side Ds1 to the second scanning side Ds2.

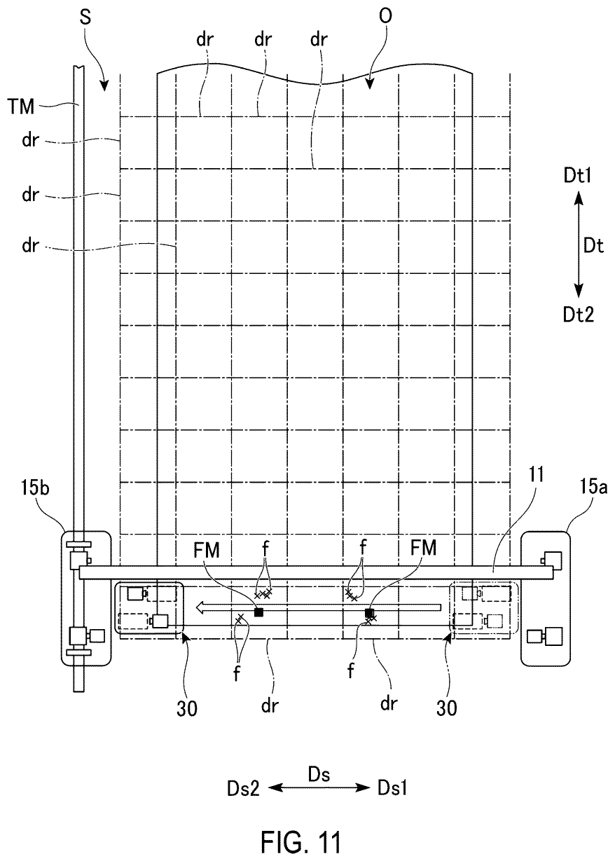

In the movement stage of the camera unit 30 to the second scanning side Ds2, the marker control unit 66 of the controller 60 operates the pen-lifting actuator 49 of the marker 47 and, as illustrated in FIG. 11, causes the marking pen 48 to mark a defect-suspected mark FM in a region including the defect-suspected portion f identified by the image processing unit 67 on the surface of the object O. Therefore, in the present embodiment, the worker can easily recognize the region where the defect-suspected portion f exists in the object O. In the present embodiment, it is necessary to cause each of the cameras 31a and 31b to image the object O, and to return the camera unit 30 to the second scanning side Ds2 after this camera unit 30 moves to the first scanning side Ds1. In the present embodiment, by causing the marker 47 to mark the defect-suspected mark FM in the stage of returning this camera unit 30 to the second scanning side Ds2, it is no longer necessary to move the camera unit 30 unnecessarily when marking the defect-suspected mark FM.

As illustrated in FIG. 11, a plurality of divided regions dr are predetermined for a region on the object placement surface S that the camera unit 30 is capable of imaging by movement of the camera unit 30 in the travel direction Dt and in the scanning direction Ds. These plurality of divided regions dr are stored in the integrated control unit 60i or the marker control unit 66 of the controller 60. The marker control unit 66 causes the marker 47 to mark the defect-suspected mark FM at substantially the center of a region overlapping the divided region dr where the defect-suspected portion f is positioned among the plurality of divided regions dr on the surface of the object O placed on the object placement surface S. In the present embodiment, even in a case where a plurality of defect-suspected portions f are positioned in one divided region dr among the plurality of divided regions dr, one defect-suspected mark FM is marked at the center of the region overlapping this one divided region dr. Therefore, in the present embodiment, it is not necessary to perform marking for each of the plurality of defect-suspected portions f, it is possible to efficiently perform this marking, and it is possible to shorten the marking time.

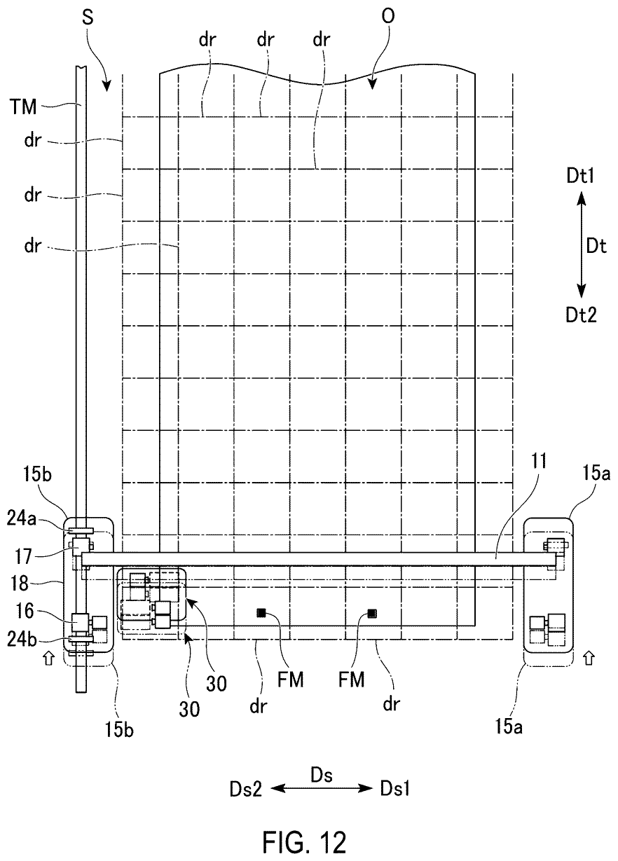

When the camera unit 30 reaches the limit position on the second scanning side Ds2 in the guide rail 11 and returns to the scanning start position, the travel control unit 61 operates the first traveling unit 15a and the second traveling unit 15b. As illustrated in FIG. 12, these operations of the first traveling unit 15a and the second traveling unit 15b move the appearance inspection device IE to the first travel side Dt1. During the movement of this appearance inspection device IE to the first travel side Dt1, the first mark sensor 24a and the second mark sensor 24b detect the position of the travel direction mark TM in the scanning direction Ds. The travel control unit 61 of the controller 60 controls the drive amount of the driving wheel 16 of the first traveling unit 15a and the drive amount of the driving wheel 16 of the second traveling unit 15b such that each deviation falls within a predetermined range in accordance with the deviation in the scanning direction Ds with respect to the travel direction mark TM detected by the first mark sensor 24a and the deviation in the scanning direction Ds with respect to the travel direction mark TM detected by the second mark sensor 24b. For this reason, in the movement stage the appearance inspection device IE to the first travel side Dt1, it is possible to minimize the blur in the scanning direction Ds of the appearance inspection device IE.

The travel control unit 61 stops the first traveling unit 15a and the second traveling unit 15b when the appearance inspection device IE moves by a distance corresponding to the width of the travel direction Dt of the effective imaging region 34a of the first camera 31a or the width of the travel direction Dt of the effective imaging region 34b of the second camera 31b.

When the first traveling unit 15a and the second traveling unit 15b stop, as described above, the first illuminator 35a and the second illuminator 35b start illuminating the surface of the object O, and the first camera 31a and the second camera 31b start imaging the surface of the object O. Then, the scanning-direction movable unit 25 operates, and the camera unit 30 moves to the first scanning side Ds1. That is, scanning in the scanning direction Ds by the camera unit 30 is executed. The image processing unit 67 sequentially analyzes the image data obtained by the first camera 31a and the second camera 31b during the above scanning and identifies the defect-suspected portion f on the surface of the object O.

When the camera unit 30 reaches the limit position on the first scanning side Ds1 in the guide rail 11, as described above, the first illuminator 35a and the second illuminator 35b are turned off, and the first camera 31a and the second camera 31b stop the imaging operation. Then, the scanning-direction movable unit 25 operates, and the camera unit 30 moves to the second scanning side Ds2. In the movement stage of this camera unit 30 to the second scanning side Ds2, the marker 47 marks the defect-suspected mark FM in the region including the defect-suspected portion f identified by the image processing unit 67 on the surface of the object O.

When the camera unit 30 reaches the limit position on the second scanning side Ds2 in the guide rail 11 and returns to the scanning start position, the first traveling unit 15a and the second traveling unit 15b operate, and the appearance inspection device IE moves to the first travel side Dt1.

As described above, the scanning of the object O in the scanning direction Ds, the marking on the object O, and the movement of the appearance inspection device IE in the travel direction Dt are repeatedly executed to complete the appearance inspection of the entire surface of the object O.

The communication unit 68 of the controller 60 sequentially outputs, to the outside, the information on the defect-suspected portion f on the surface of the object O identified by the image processing unit 67. The communication unit 68 may output, to the outside, the information on the defect-suspected portion f on the surface of the object O identified by the image processing unit 67 after the appearance inspection of the entire surface of the object O is completed.

As described above, in the present embodiment, since the movement of the movable frame 10 and the camera unit 30 in the travel direction Dt by the operation of the first traveling unit 15a and the second traveling unit 15b and the movement of the camera unit 30 in the scanning direction Ds perpendicular to the travel direction Dt by the operation of the scanning-direction movable unit 25 are possible, the appearance inspection of the object O is possible even in a case where the size of this object O is large with respect to the imaging regions 33a and 33b of the cameras 31a and 31b.

The object placement surface S may have distortion or fine unevenness. Therefore, during the movement of the movable frame 10 and the camera unit 30 in the travel direction Dt by the operation of the first traveling unit 15a and the second traveling unit 15b, the camera unit 30 vibrates due to distortion and fine unevenness of the object placement surface S. In the present embodiment, the cameras 31a and 31b are not caused to image the object O during the movement in the travel direction Dt in which the camera unit 30 vibrates, and the cameras 31a and 31b are caused to image the object O during the movement of the camera unit 30 in the scanning direction Ds along the guide rail 11. Therefore, in the present embodiment, it is possible to suppress the vibration of the cameras 31a and 31b during the imaging of the object O by the cameras 31a and 31b and improve the accuracy of the appearance inspection of the object O.

### Modification Examples

The arrangement of the first camera 31a, the second camera 31b, the first illuminator 35a, the second illuminator 35b, and the like in the camera unit 30 is not limited to that of the present embodiment.

The appearance inspection device IE in the above embodiment includes the two cameras 31a and 31b and the two illuminators 35a and 35b. However, each of the camera and the illuminator may be three or more or one. However, in order to efficiently inspect the surface of the object O, it is preferable that a plurality of cameras and a plurality of illuminators are provided.

The disclosure is not limited to each embodiment described above. Various additions, changes, substitutions, partial deletions, and the like can be made in a range without deviating from the conceptual idea and the essence of the disclosure derived from the content and equivalents thereof defined in the claims.

### Supplementary Notes

The appearance inspection device IE in the above embodiment and modification example is grasped as follows, for example.
(1) An appearance inspection device IE in a first aspect includes: a movable frame 10 including a guide rail 11 extending in a scanning direction Ds; a first traveling unit 15a and a second traveling unit 15b that are capable of traveling on an object placement surface S in a travel direction Dt perpendicular to the scanning direction Ds; a scanning-direction movable unit 25 attached to the guide rail 11 and movable in the scanning direction Ds along the guide rail 11; a camera unit 30 attached to the scanning-direction movable unit 25 and including cameras 31a and 31b capable of imaging an object O placed on the object placement surface S and illuminators 35a and 35b capable of illuminating imaging regions 33a and 33b of the cameras 31a and 31b; and a controller 60 capable of controlling respective operations of the first traveling unit 15a, the second traveling unit 15b, the scanning-direction movable unit 25, and the cameras 31a and 31b. The movable frame 10 includes a first leg 14a configured to support an end of the guide rail 11 on a first scanning side Ds1, which is one side in the scanning direction Ds, and extending in a direction having a component in a vertical direction Dv and a second leg 14b configured to support an end of the guide rail 11 on a second scanning side Ds2 opposite to the first scanning side Ds1 in the scanning direction Ds and extending in a direction having the component in the vertical direction Dv. The first traveling unit 15a is attached to a lower end of the first leg 14a. The second traveling unit 15b is attached to a lower end of the second leg 14b. The controller 60 operates the scanning-direction movable unit 25 and causes the cameras 31a and 31b to image the object O while the camera unit 30 is moving in the scanning direction Ds.

In the present aspect, since the movement of the movable frame 10 and the camera unit 30 in the travel direction Dt by the operation of the first traveling unit 15a and the second traveling unit 15b and the movement of the camera unit 30 in the scanning direction Ds perpendicular to the travel direction Dt by the operation of the scanning-direction movable unit 25 are possible, the appearance inspection of the object O is possible even in a case where the size of this object O is large with respect to the imaging regions 33a and 33b of the cameras 31a and 31b.

The object placement surface S may have distortion or fine unevenness. Therefore, during the movement of the movable frame 10 and the camera unit 30 in the travel direction Dt by the operation of the first traveling unit 15a and the second traveling unit 15b, the camera unit 30 vibrates due to distortion and fine unevenness of the object placement surface S. In the present aspect, the cameras 31a and 31b are caused to image the object O while the camera unit 30 is moving in the scanning direction Ds along the guide rail 11. Therefore, in the present aspect, it is possible to suppress the vibration of the cameras 31a and 31b during the imaging of the object O by the cameras 31a and 31b and improve the accuracy of the appearance inspection of the object O.
(2) The appearance inspection device IE in a second aspect is the appearance inspection device IE in the first aspect, wherein the controller 60 operates the first traveling unit 15a and the second traveling unit 15b and causes the cameras 31a and 31b to stop imaging the object O while the movable frame 10 and the camera unit 30 are moving in the travel direction Dt.

In the present aspect, as described above, the cameras 31a and 31b are not caused to image the object O during the movement in the travel direction Dt in which the camera unit 30 vibrates, and the cameras 31a and 31b are caused to image the object O during the movement of the camera unit 30 in the scanning direction Ds along the guide rail 11. Therefore, in the present aspect, it is possible to suppress the vibration of the cameras 31a and 31b during the imaging of the object O by the cameras 31a and 31b and improve the accuracy of the appearance inspection of the object O.
(3) The appearance inspection device IE in a third aspect is the appearance inspection device IE in the first aspect or the second aspect and includes a first mark sensor 24a and a second mark sensor 24b provided on the object placement surface S and capable of detecting a position in the scanning direction Ds of a travel direction mark TM extending in the travel direction Dt. Each of the first traveling unit 15a and the second traveling unit 15b includes a driving wheel 16. The first mark sensor 24a is arranged on a first travel side Dt1, which is one side in the travel direction Dt, with respect to one driving wheel 16 of the driving wheel 16 of the first traveling unit 15a and the driving wheel 16 of the second traveling unit 15b. The second mark sensor 24b is arranged on a second travel side Dt2 opposite to the first travel side Dt1 in the travel direction Dt with respect to the one driving wheel 16. The controller 60 is capable of controlling a drive amount of the driving wheel 16 of the first traveling unit 15a and a drive amount of the driving wheel 16 of the second traveling unit 15b in accordance with a deviation in the scanning direction Ds with respect to the travel direction mark TM detected by the first mark sensor 24a and a deviation in the scanning direction Ds with respect to the travel direction mark TM detected by the second mark sensor 24b.

In the present aspect, the drive amount of the driving wheel 16 of the first traveling unit 15a and the drive amount of the driving wheel 16 of the second traveling unit 15b are controlled in accordance with the deviation in the scanning direction Ds with respect to the travel direction mark TM detected by the first mark sensor 24a and the deviation in the scanning direction Ds with respect to the travel direction mark TM detected by the second mark sensor 24b. Therefore, in the present aspect, in the movement stage of the appearance inspection device IE in the travel direction Dt, it is possible to minimize the blur in the scanning direction Ds of the appearance inspection device IE.
(4) The appearance inspection device IE in a fourth aspect is the appearance inspection device IE in any one aspect of the first aspect to the third aspect, wherein the controller 60 causes the cameras 31a and 31b to image the object O when the camera unit 30 is moving to the first scanning side Ds1. The camera unit 30 includes a wiper 41 arranged on the first scanning side Ds1 relative to the cameras 31a and 31b, contacting a surface of the object O, and capable of removing foreign matter on the surface.

In the present aspect, when the cameras 31a and 31b are moving to the first scanning side Ds1, the foreign matter in the region to be imaged by the cameras 31a and 31b on the surface of the object O can be removed in advance by the wiper 41. Therefore, in the present aspect, it is possible to reduce erroneous detection of the defect-suspected portion f due to foreign matter.
(5) The appearance inspection device IE in a fifth aspect is the appearance inspection device IE in any one aspect of the first aspect to the fourth aspect and includes a lifting unit 26 capable of moving the camera unit 30 in a vertical direction Dv. The camera unit 30 is attached to the scanning-direction movable unit 25 via the lifting unit 26. The camera unit 30 includes a distance meter 46 capable of measuring a distance to the surface of the object O. The controller 60 operates the lifting unit 26 based on the distance to the surface of the object O measured by the distance meter 46 such that the distance from the cameras 31a and 31b to a portion to be imaged by the cameras 31a and 31b on the surface of the object O becomes a predetermined distance.

In the present aspect, even if the surface of the object O is displaced in the up-down direction according to the position in the scanning direction Ds, the cameras 31a and 31b are focused on the surface of the object O, and the illumination intensity in the illumination regions 37a and 37b on the surface of the object O becomes constant.
(6) The appearance inspection device IE in a sixth aspect is the appearance inspection device IE in any one aspect of the first aspect to the fifth aspect, wherein the cameras 31a and 31b include a first camera 31a and a second camera 31b. The second camera 31b is arranged on the first travel side Dt1 relative to the first camera 31a such that the first travel side Dt1, which is one side in the travel direction Dt, becomes an imaging region 33b with respect to an imaging region 33a of the first camera 31a.

In the present aspect, two regions different from each other in the travel direction Dt can be imaged by the two cameras 31a and 31b by one movement of the camera unit 30 in the scanning direction Ds. Therefore, in the present aspect, it is possible to efficiently inspect the surface of the object O.
(7) The appearance inspection device IE in a seventh aspect is the appearance inspection device IE in the sixth aspect, wherein the illuminators 35a and 35b include a first illuminator 35a and a second illuminator 35b. The first illuminator 35a is arranged at a position where it is capable of illuminating the imaging region 33a of the first camera 31a. The second illuminator 35b is arranged at a position where it is capable of illuminating the imaging region 33b of the second camera 31b.
(8) The appearance inspection device IE in an eighth aspect is the appearance inspection device IE in any one aspect of the first aspect to the seventh aspect, wherein the controller 60 includes an image processing unit 67 configured to identify a defect-suspected portion f on the surface of the object O based on imaging data obtained by the cameras 31a and 31b.
(9) The appearance inspection device IE in a ninth aspect is the appearance inspection device IE in the eighth aspect, wherein the image processing unit 67 identifies the defect-suspected portion f on the surface of the object O based on imaging data of effective imaging regions 34a and 34b in which illumination intensity by the illuminators 35a and 35b is equal to or more than a predetermined illumination intensity in imaging regions 33a and 33b of the cameras 31a and 31b.

In the present aspect, it is possible to reduce erroneous detection of the defect-suspected portion f.
(10) The appearance inspection device IE in a tenth aspect is the appearance inspection device IE in the eighth aspect or the ninth aspect, wherein the camera unit 30 includes a marker 47 capable of marking a defect-suspected mark FM on a part of the surface of the object O. The controller 60 causes the marker 47 to mark the defect-suspected mark FM in a region including the defect-suspected portion f identified by the image processing unit 67 on the surface of the object O.

In the present aspect, the worker can easily recognize the region where the defect-suspected portion f exists in the object O.
(11) The appearance inspection device IE in an eleventh aspect is the appearance inspection device IE in the tenth aspect, wherein a plurality of divided regions dr are predetermined for a region on the object placement surface S that the camera unit 30 is capable of imaging by movement of the camera unit 30 in the travel direction Dt and in the scanning direction Ds. The controller 60 causes the marker 47 to mark, on the surface of the object O placed on the object placement surface S, the defect-suspected mark FM in a region overlapping a divided region dr where the defect-suspected portion f is positioned among the plurality of divided regions dr.

In the present aspect, the defect-suspected mark FM is marked in a region overlapping a divided region dr where the defect-suspected portion f is positioned on the surface of the object O. Therefore, in the present aspect, it is not necessary to perform marking for each of the plurality of defect-suspected portions f, it is possible to efficiently perform this marking, and it is possible to shorten the marking time.
(12) The appearance inspection device IE in a twelfth aspect is the appearance inspection device IE in the tenth aspect or the eleventh aspect, wherein the controller 60 causes the cameras 31a and 31b to image the object O when the camera unit 30 is moving to the first scanning side Ds1 and causes the marker 47 to mark the defect-suspected mark FM when the camera unit 30 is moving to the second scanning side Ds2 after moving to the first scanning side Ds1.

In the present aspect, it is necessary to cause the cameras 31a and 31b to image the object O, and to return the camera unit 30 to the second scanning side Ds2 after this camera unit 30 moves to the first scanning side Ds1. In the present aspect, by causing the marker 47 to mark the defect-suspected mark FM in the stage of returning this camera unit 30 to the second scanning side Ds2, it is no longer necessary to move the camera unit 30 unnecessarily when marking the defect-suspected mark FM.
(13) The appearance inspection device IE in a thirteenth aspect is the appearance inspection device IE in any one aspect of the eighth aspect to the twelfth aspect, wherein the controller 60 includes a communication unit 68 capable of outputting, to an outside, data indicating a position of the defect-suspected portion f identified by the image processing unit 67 on the surface of the object O.

In the present aspect, it is possible to convey information on the defect-suspected portion f not only to the worker at the site where the object placement surface S exists but also to a person who is not at the site.
(14) The appearance inspection device IE in a fourteenth aspect is the appearance inspection device IE in any one aspect of the first aspect to the thirteenth aspect, wherein the illuminators 35a and 35b can adjust illumination intensity.

By appropriately adjusting the illumination intensities of the illuminators 35a and 35b, it is possible to reduce erroneous detection of the defect-suspected portion f.
(15) The appearance inspection device IE in a fifteenth aspect is the appearance inspection device IE in any one aspect of the first aspect to the fourteenth aspect including: a first caster 21a including a wheel 22 capable of rolling on the object placement surface S; a first jack 23a capable of lifting the first leg 14a with respect to the first caster 21a; a second caster 21b including a wheel 22 capable of rolling on the object placement surface S; and a second jack 23b capable of lifting the second leg 14b with respect to the second caster 21b.

In the present aspect, the appearance inspection device IE can be easily moved to a target position on the object placement surface S.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. An appearance inspection device, comprising:
a movable frame including a guide rail extending in a scanning direction;
a first traveling unit and a second traveling unit that are capable of traveling on an object placement surface in a travel direction perpendicular to the scanning direction;
a scanning-direction movable unit attached to the guide rail and movable in the scanning direction along the guide rail;
a camera unit attached to the scanning-direction movable unit and including a camera capable of imaging an object placed on the object placement surface and an illuminator capable of illuminating an imaging region of the camera; and
a controller capable of controlling respective operations of the first traveling unit, the second traveling unit, the scanning-direction movable unit, and the camera, wherein
the movable frame includes a first leg configured to support an end of the guide rail on a first scanning side, which is one side in the scanning direction, and extending in a direction having a component in a vertical direction Dv and a second leg configured to support an end of the guide rail on a second scanning side opposite to the first scanning side in the scanning direction and extending in a direction having the component in the vertical direction Dv,
the first traveling unit is attached to a lower end of the first leg,
the second traveling unit is attached to a lower end of the second leg, and
the controller operates the scanning-direction movable unit and causes the camera to image the object while the camera unit is moving in the scanning direction.

2. The appearance inspection device according to claim 1, wherein the controller operates the first traveling unit and the second traveling unit and causes the camera to stop imaging the object while the movable frame and the camera unit are moving in the travel direction.

3. The appearance inspection device according to claim 1, comprising
a first mark sensor and a second mark sensor provided on the object placement surface and capable of detecting a position in the scanning direction of a travel direction mark extending in the travel direction, wherein
each of the first traveling unit and the second traveling unit includes a driving wheel,
the first mark sensor is arranged on a first travel side, which is one side in the travel direction, with respect to one driving wheel of the driving wheel of the first traveling unit and the driving wheel of the second traveling unit,
the second mark sensor is arranged on a second travel side opposite to the first travel side in the travel direction with respect to the one driving wheel, and
the controller is capable of controlling a drive amount of the driving wheel of the first traveling unit and a drive amount of the driving wheel of the second traveling unit in accordance with a deviation in the scanning direction with respect to the travel direction mark detected by the first mark sensor and a deviation in the scanning direction with respect to the travel direction mark detected by the second mark sensor.

4. The appearance inspection device according to claim 1, wherein the controller causes the camera to image the object when the camera unit is moving to the first scanning side, and
the camera unit includes a wiper arranged on the first scanning side relative to the camera, contacting a surface of the object, and capable of removing foreign matter on the surface.

5. The appearance inspection device according to claim 1, comprising
a lifting unit capable of moving the camera unit in a vertical direction, wherein
the camera unit is attached to the scanning-direction movable unit via the lifting unit and includes a distance meter capable of measuring a distance to a surface of the object, and
the controller operates the lifting unit based on a distance to a surface of the object measured by the distance meter such that a distance from the camera to a portion to be imaged by the camera on the surface of the object becomes a predetermined distance.

6. The appearance inspection device according to claim 1, wherein
the camera includes a first camera and a second camera, and
the second camera is arranged on the first travel side relative to the first camera such that the first travel side, which is one side in the travel direction, is within an imaging region of the second camera with respect to an imaging region of the first camera.

7. The appearance inspection device according to claim 6, wherein
the illuminator includes a first illuminator and a second illuminator,
the first illuminator is arranged at a position where it is capable of illuminating the imaging region of the first camera, and
the second illuminator is arranged at a position where it is capable of illuminating the imaging region of the second camera.

8. The appearance inspection device according to claim 1, wherein the controller includes an image processing unit configured to identify a defect-suspected portion on a surface of the object based on imaging data obtained by the camera.

9. The appearance inspection device according to claim 8, wherein the image processing unit identifies the defect-suspected portion on the surface of the object based on imaging data of an effective imaging region in which illumination intensity by the illuminator is equal to or more than a predetermined illumination intensity in the imaging region of the camera.

10. The appearance inspection device according to claim 8, wherein
the camera unit includes a marker capable of marking a defect-suspected mark on a part of the surface of the object, and
the controller causes the marker to mark the defect-suspected mark in a region including the defect-suspected portion identified by the image processing unit on the surface of the object.

11. The appearance inspection device according to claim 10, wherein
a plurality of divided regions are predetermined for a region on the object placement surface that the camera unit is capable of imaging by movement of the camera unit in the travel direction and in the scanning direction, and
the controller causes the marker to mark, on the surface of the object placed on the object placement surface, the defect-suspected mark in a region overlapping a divided region where the defect-suspected portion is positioned among the plurality of divided regions.

12. The appearance inspection device according to claim 10, wherein the controller causes the camera to image the object when the camera unit is moving to the first scanning side and causes the marker to mark the defect-suspected mark when the camera unit is moving to the second scanning side after moving to the first scanning side.

13. The appearance inspection device according to claim 8, wherein the controller includes a communication unit capable of outputting, to an outside, data indicating a position of the defect-suspected portion identified by the image processing unit on the surface of the object.

14. The appearance inspection device according to claim 1, wherein the illuminator is capable of adjusting illumination intensity.

15. The appearance inspection device according to claim 1, comprising:
a first caster including a wheel capable of rolling on the object placement surface;
a first jack capable of lifting the first leg with respect to the first caster;
a second caster including a wheel capable of rolling on the object placement surface; and
a second jack capable of lifting the second leg with respect to the second caster.
